(19) United States
(12) Patent Application Publication
(10) Pub. No.: US 2012/0285386 A1
(43) Pub. Date: Nov. 15, 2012

(54) Bird Feeder

(75) Inventors: Robert E. Miller, San Francisco, CA (US); Tristan Christianson, San Francisco, CA (US)

(73) Assignee: ABSOLUTELYNEW, INC., San Francisco, CA (US)

(21) Appl. No.: 13/468,456

(22) Filed: May 10, 2012

Related U.S. Application Data
(60) Provisional application No. 61/484,577, filed on May 10, 2011.

(51) Int. Cl. A01K 39/014

(52) U.S. Cl. 119/52.2

(57) ABSTRACT

A bird feeder comprising of a free spinning plate guards to prevent unwanted pests such as squirrels from accessing the seed within the feeder. Whereas birds can feed while resting on perches which protrude outwardly from the bottom portion of the feeder, non-flying pest animals such as squirrels must approach the feeder along its outer periphery, traversing the plate guards in the process. As the pest tries to climb onto the feeder and access the seed, the plate guards spin; preventing the pest from having a stable footing and thus fall off the feeder.

### CROSS-REFERENCE TO RELATED APPLICATIONS

None.

### FEDERALLY SPONSORED RESEARCH

Not Applicable.

### SEQUENCE LISTING

None.

### BACKGROUND OF THE PRESENT INVENTION

1. Technical Field

The invention pertains to devices for feeding seed to birds and particularly to such devices which guard the seed against squirrels and other predators by using a movable barrier.

2. Prior Art

In U.S. Pat. No. 6,598,561, issued Jul. 29, 2003, Johns discloses a bird feeder which includes a cylindrically shaped outer shell, where the shell is free to move about a structure having first and second generally drum-like faces. As a predator tries to climb the feeder, the outer shell spins such the animal loses both of its footing and any chance of accessing the feeder. In U.S. Pat. No. 5,195,495, which issued Mar. 23, 1993, Ancketill discloses a feeder that is closed by the weight of a squirrel or the like as the animal climbs onto the feeder. In U.S. Pat. No. 5,170,750, issued Dec. 15, 1992, Ricketts discloses another variation which includes a latch which, once tripped by the weight of a squirrel or similar animal, releases a spring locked door, catapulting the pest from the feeder. In U.S. Pat. No. 4,867,104, issued Sep. 19, 1989, Vandiver discloses a pole supported feeder, the base of which has small rotatable elements which make access to the feed container difficult for a pest.

### SUMMARY OF THE INVENTION

The present invention remedies deficiencies in conventional squirrel-proof wild bird feeders by introducing a novel method of preventing unwanted squirrels from gaining a foothold on the surface of the bird feeder in order to access the seeds stored within the feeder. This method is achieved through a set of free spinning plate guards placed at the surface of the silo portion of the bird feeder. The principle of the invention rests on the premise that if the rodent cannot gain a foothold on the feeder, the rodent will have no means to access the seed contained inside the feeder.

An additional layer of deterrence is also present in the invention in the form of aversive agents added to the outer surface of the feeder. The aversive agent is ideally made of capsaicin based agents to give maximum amount of deterrence without causing injury to the birds or the predators that visit the feeder. Nonetheless, other types of aversive agents such as bitterants, with denatonium benzoate and pungent-type aversive agents can also be infused in the outer surface of the feeder as alternatives.

Another important feature present in the invention is a set of flexible perches with a maximum weight threshold such that they can only support smaller birds that usually feed on seeds. This prevents heavier animals such as the unwanted squirrels and larger birds from landing and holding on to the perches to access the seed in the trough of said bird feeder.

Another important feature of the invention is the size and shape of the silo that stores the seed. The silo design in the present invention more efficiently creates the volume available to store the seeds, and in most cases the silo is capable of holding one full bag of bird seed currently available and being sold in the market. This is an important feature because this lessens the instances of the user having to refill the bird feeder and having to store a partially used bag of seed, issues present in smaller sized bird feeders.

Yet another important feature of the invention is the location of the fill hole is protected from any access unless the feeder is inverted and the trough is opened to reveal the fill hole. This effectively eliminates any undesired access to the fill hole during normal use, and the only time the fill hole is accessible is only when it is needed to refill the bird feeder.

### DRAWINGS

FIG. 1 shows a perspective view of the bird feeder;

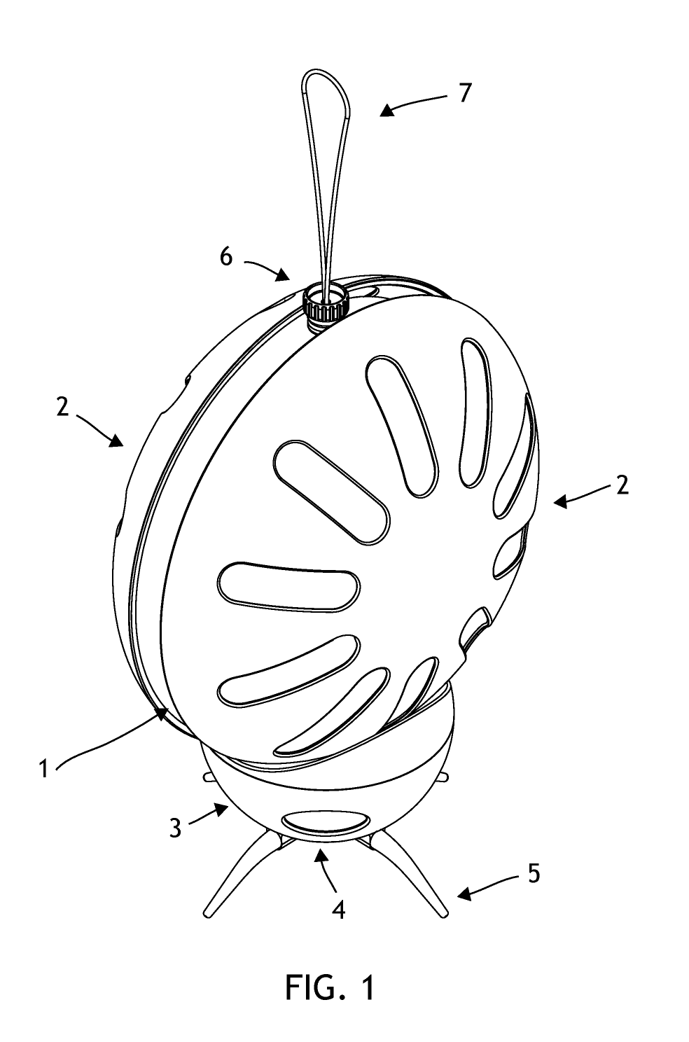

FIG. 2 shows a side view of the bird feeder;

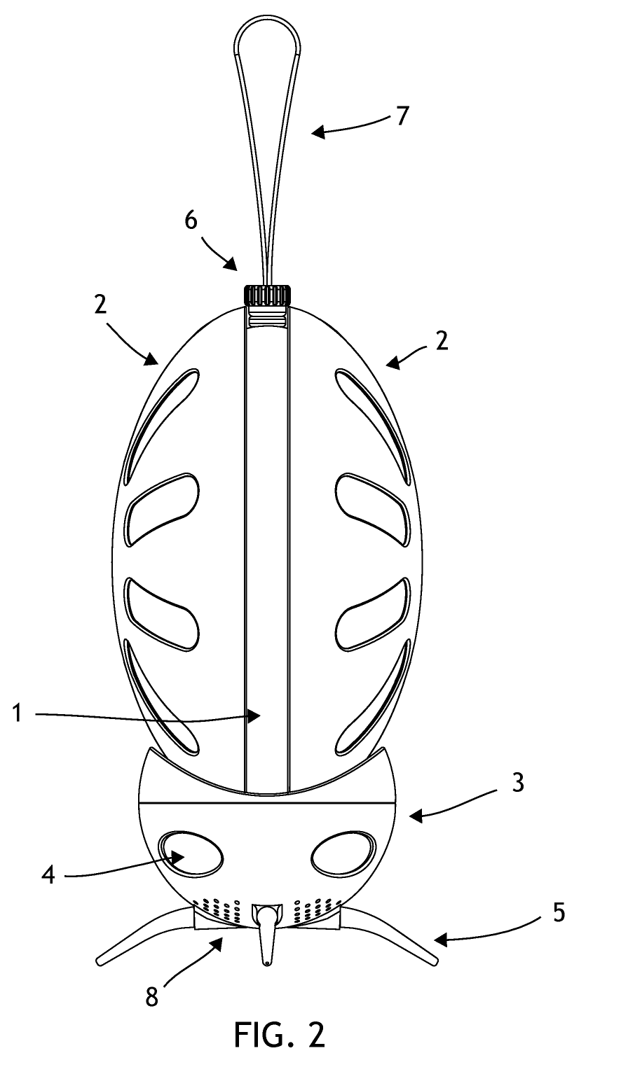

FIG. 3 shows an alternate side view of the bird feeder;

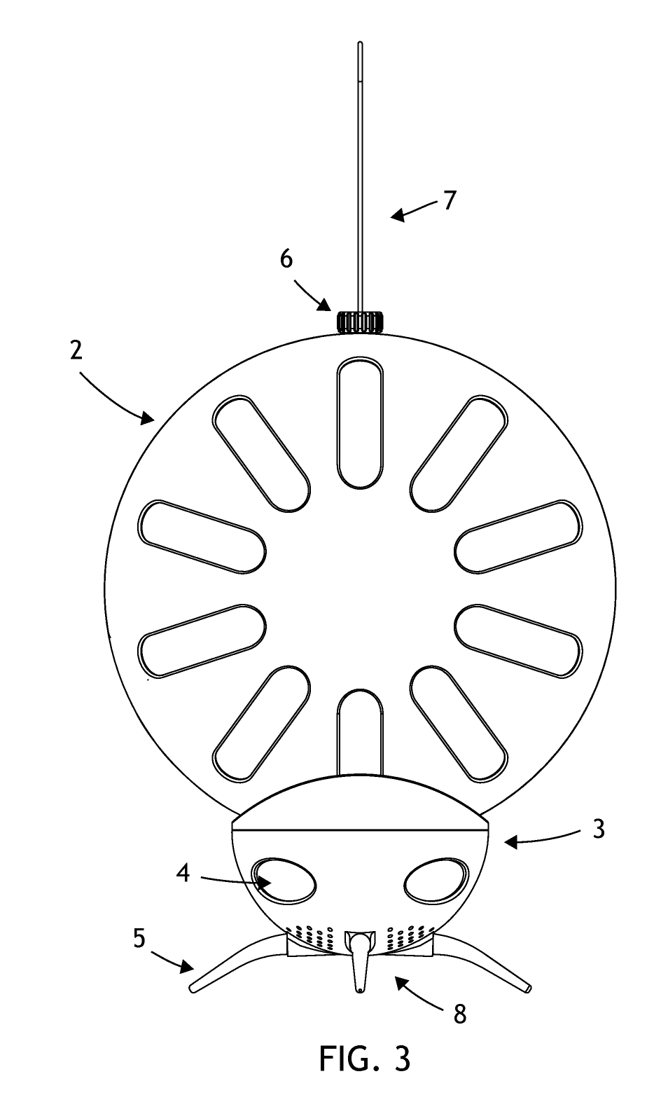

FIG. 4 shows an exploded view of the bird feeder, with the trough assembly detached from the silo that stores the seed;

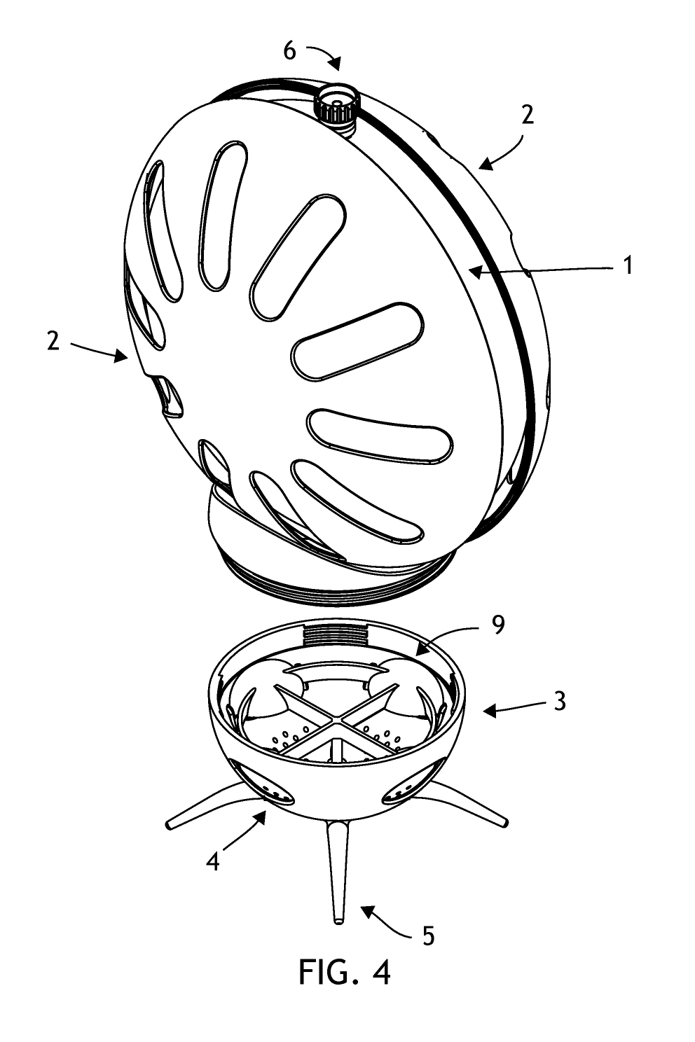

FIG. 5 shows an inverted, exploded perspective view of the bird feeder, displaying the fill hole of one embodiment of the invention.

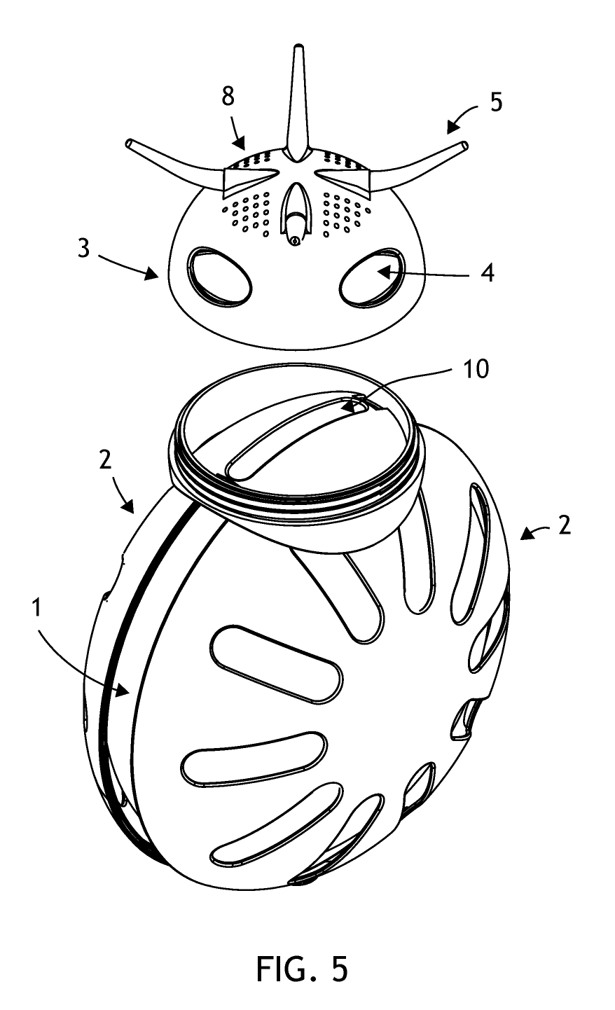

FIG. 6 shows an exploded view of the bird feeder, showing the free spinning plates separate from the silo.

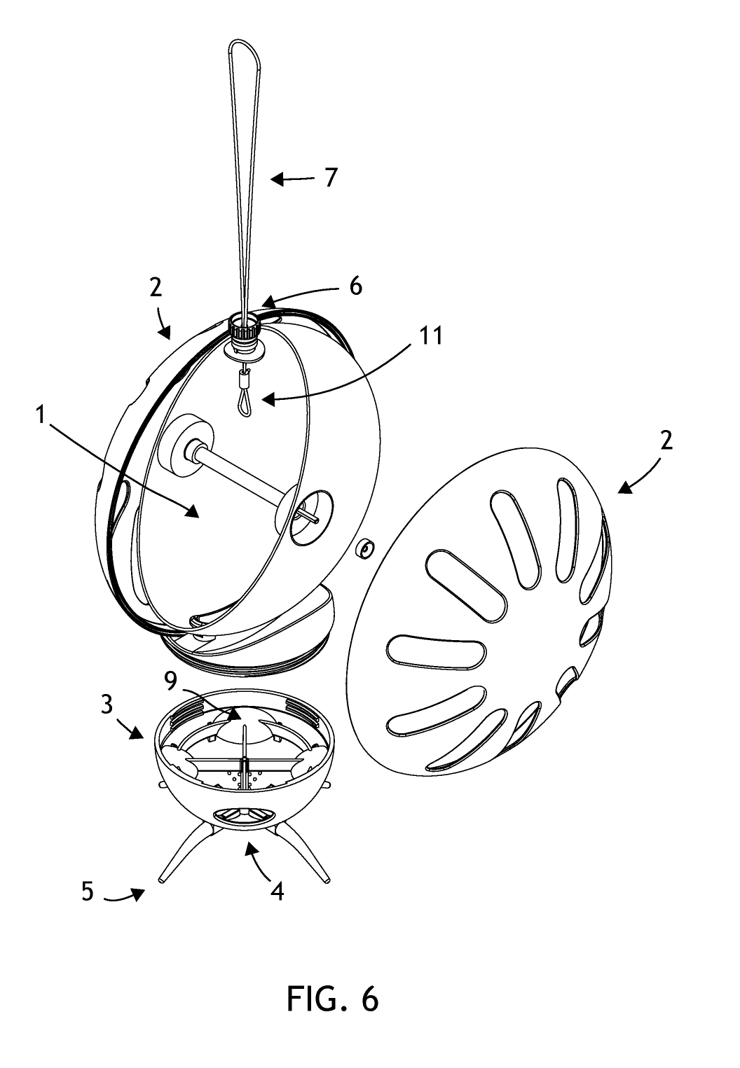

### REFERENCE NUMERALS

1 silo
2 free spinning guard plates
3 trough
4 feeding portal
5 perch
6 hanger screw cap
7 adjustable wire hanger
8 drain holes
9 seed port shield
10 silo fill hole
11 wire hanger clasp

### DETAILED DESCRIPTION OF THE PREFERRED EMBODIMENT

In the preferred embodiment, the bird feeder is typically suspended from a tree branch or a post like structure. The free spinning guard plates 2 are located a set distance from the surface of the silo 1, roughly parallel to said surface, and said plates 2 are attached to each other by an axle passing through the silo 1. The free spinning guard plates 2 are designed to prevent any rodent type pests, including squirrels from gaining a foothold to the surface of the bird feeder and to further prevent the unwanted animal from gaining access to the seed inside the silo. The term “pest” here is defined as unwanted animals that typically prey on seeds and usually invade bird seeders to gain access to the seeds stored within. Pests include rodent type animals such as squirrels, and larger birds that are not part of small birds the feeder is intended for. An alternate hanging method can be achieved by sufficiently spacing said free spinning guard plates 2 apart so that a wire hanger or post support may be attached between the edges of the plates.

The plates 2 freely spin as soon as a pest attempts to grab the surface of the silo 1, and the speed of the spinning plates is directly proportional to the weight and the momentum of the pest attempting to gain foothold on the bird feeder.

In the preferred embodiment, the fill hole 10 is located under the silo 1, functioning both as a gravity fed seed reservoir, and a secure opening to the seed that is completely inaccessible to unwanted intrusions from squirrels and the like. The shape of the fill hole 10 can be the shape of a slit as shown in the drawings, or a hole with the size of the diameter of the inner wall of the silo 1. An optional attachment piece to funnel the seed can also be included to assist users during the process of filling the silo with seed. In an alternate embodiment, the fill hole 10 is repositioned to the upper portion of the silo 1, thus allowing the silo 1 to be filed without inverting the bird feeder. However, the downside of this embodiment is pests have an easier opportunity to reach and access the fill hole, therefore making the seeds inside the silo in a more vulnerable.

The trough 3 is located and removably attached to the lower portion of the silo 1 in the preferred embodiment of this invention. The trough 3 features seed port shield 9 to regulate the flow of seeds coming out of the silo 1 to the trough 3. Without the seed port shields, the seeds would immediately begin to flow out of the silo 1 when the user returns the bird feeder to its upright operating position after filling it with seed.

A plurality of perches 5 are attached to the trough 3. In the preferred embodiment, the perches 5 are made of flexible materials, with the characteristic of having sufficient flexibility to prevent larger sized birds or unwanted pests from gaining foothold and access to the seed from the feeding portals 4. If an animal lands on the perch weighs beyond the threshold limit of the perches, the perches 5 will simply collapse under the animal's weight. The perches 5 will flex back to its original shape as soon as the weight clears from the perches.

The feeding portal 4 should ideally be a rounded shape, to prevent unintentional injuries and of sufficient size to prevent a situation where a bird's head could get stuck inside the portal 4 during feeding sessions. The drain holes 8 located at the bottom of the trough 3 are used to prevent moisture build up within the trough 3 which can create an unwanted buildup of lumped seeds.

The hanger screw cap 6 can be opened to easily adjust the length of the wire hanger 7 by slidably adjusting the position of the wire hanger clasp 11 relative to the length of the wire to clamp the ends of the wire hanger 7 at the desired length. The remainder of the length of the wire hanger 7 below the wire hanger clasp 11 may then be stowed within the confined space of the silo 1.

The aversive agents can be applied to the external surface of the bird feeder, particularly in areas where pests are likely to gain foothold on the surface of the feeder by biting the materials. Surface areas such as the guard plates 2 and the perches 5 are primary bite targets for pests that somehow avoid or that are undeterred by the spinning action of the guard plates 2. The aversive agents are non-toxic substances to deter pests from the feeder but have no adverse or deterrent effect on birds.

In the preferred embodiment, more than one aversive agents are introduced to the surface of the bird feeder. Bitterants such as Denatonium Benzoate and capsaicin-based agents are combined to maximize the deterrent effect to the pests that still manage to gain foothold on the surface of the bird feeder. The aversive agents can be painted to the surface of the bird feeder, or infused to the material of the external surface of the bird feeder.

Therefore, the foregoing should be considered as illustrative only of the principles of the invention. Further, since numerous modifications and changes will readily occur to those skilled in the art, it is not desired to limit the invention to the exact construction and operation shown and described, and accordingly, all suitable modifications and equivalents that may be resorted to, fall within the scope of the invention.

We claim:

1. A bird feeder comprising:
a. A silo;
b. A plurality of free spinning plates, each located a set distance from the surface of said silo, roughly parallel to said surface, attached so that each spins freely in a roughly vertical plane;
c. A fill hole in the silo;
d. A seed trough with at least one feeding portal;
e. One or more perches located to allow birds to reach the feeding portals.

2. A bird feeder of claim 1, further comprising a hanging loop flexible tension element that is adjustable in length.

3. A bird feeder of claim 1, where said seed trough is removably attached to the lower portion of said silo.

4. A bird feeder of claim 1, where said perches are made of flexible materials of sufficient flexibility to support no greater than the weight of the birds intended for the feeder.

5. A bird feeder of claim 1, where said perches are removably attached to said seed trough.

6. A bird feeder of claim 1, where said bird feeder is removably attached to a post or post-like structure.

7. A bird feeder of claim 1, where said fill hole is located at the bottom of the silo and enclosed by the seed trough.

8. A bird feeder of claim 1, where said fill hole further comprises a seed funneling attachment piece.

9. A bird feeder of claim 1, where said fill hole is located on the upper rim of the silo.

10. A bird feeder of claim 1, where said spinning plates are spaced sufficiently apart so that a wire hanger or post support may be attached between the edges of the plates.

11. A bird feeder of claim 1, where said spinning plates are independently attached to the silo without an axle between them.

12. A bird feeder of claim 1, further comprising at least one seed port shield over said feed portals.

13. A bird feeder comprising:
a. A silo;
b. A plurality of free spinning plates, each located a set distance from the surface of said silo, roughly parallel to said surface, attached to each other by an axle passing through the silo;
c. A fill hole in the silo;
d. A seed trough with at least one feeding portal;
e. At least one or more perches located on said trough to allow birds to reach the feeding portals.
f. At least one type of aversive agent applied to the external surface area of said bird feeder.

14. A bird feeder of claim 13, further comprising of a hanging loop that is adjustable in length.

15. A bird feeder of claim 13, where said seed trough is removably attached to the lower portion of said silo.

16. A bird feeder of claim 13, where said perches are made of flexible materials of sufficient rigidity to support no greater than the weight of the birds intended for the feeder.

17. A bird feeder of claim 13, where said perches are removably attached to said seed trough.

18. A bird feeder of claim 13, where said bird feeder is removably attached to a post or post-like structure.

19. A bird feeder of claim 13, where said fill hole is located at the bottom of the silo and enclosed by the seed trough.

20. A bird feeder of claim 13, where said fill hole further comprises a seed funneling attachment piece.

21. A bird feeder of claim 13, where said fill hole is located on the upper rim of the silo.

22. A bird feeder of claim 13, where said spinning plates are vertically oriented so that the attach cord or post attachment is between the plates.

23. A bird feeder of claim 13, where said spinning plates are independently attached to the silo without an axle between them.

24. A bird feeder of claim 13, further comprising at least one seed port shield over said feed portals.

25. A bird feeder of claim 13, where said aversive agent is applied by painting said aversive agent to the external surface of said bird feeder.

26. A bird feeder of claim 13, where said aversive agent is infused to the external surface of said bird feeder.

27. A bird feeder of claim 13, where said aversive agent further comprises bitterants.

28. A bird feeder of claim 13, where said aversive agent further comprises capsaicin based agents.
